(19) United States
(12) Patent Application Publication
(10) Pub. No.: US 2012/0062435 A1
(43) Pub. Date: Mar. 15, 2012

(54) MAGNETIC SHEET, ANTENNA MODULE, ELECTRONIC APPARATUS, AND MAGNETIC SHEET MANUFACTURING METHOD

(75) Inventors: Yoshihiro Kato, Kanagawa (JP); Shinichi Fukuda, Kanagawa (JP); Kenichi Kabasawa, Saitama (JP); Yoshito Ikeda, Tochigi (JP); Keisuke Matsunami, Tokyo (JP)

(73) Assignee: SONY CORPORATION, Tokyo (JP)

(21) Appl. No.: 13/321,615

(22) PCT Filed: Mar. 22, 2011
(86) PCT No.: PCT/JP2011/001667

§ 371 Date: Nov. 21, 2011

(30) Foreign Application Priority Data
Mar. 29, 2010 (JP) P2010-074956

(51) Int. Cl. H01Q 1/00; B05D 5/00

(52) U.S. Cl. 343/787; 427/127

(57) ABSTRACT

A magnetic sheet for use with an antenna module is provided. The magnetic sheet may have a magnetically permeable layer having a plurality of randomly shaped pieces such that the magnetic sheet is configured to affect a resonance frequency of the antenna module. At least one of the randomly shaped pieces of the magnetic sheet does not have a rectangular or triangular shape.

### CROSS-REFERENCE TO RELATED APPLICATION

The present application claims priority from Japanese Patent Application No. JP 2010-74956 filed in the Japanese Patent Office on Mar. 29, 2010, the entire content of which is incorporated herein by reference.

### TECHNICAL FIELD

1. [Background Art]

The present disclosure relates to a magnetic sheet provided next to an antenna, an antenna module using the magnetic sheet, an electronic apparatus on which the antenna module is mounted, and a manufacturing method of the magnetic sheet.

2. Description of the Related Art

In recent years, a plurality of RF (Radio Frequency) antennas are mounted on a wireless communication device. Taking a mobile phone as an example, a telephone communication antenna (700 MHz-2.1 GHz), a one-segment antenna (470-700 MHz), a GPS antenna (1.5 GHz), a wireless LAN/Bluetooth antenna (2.45 GHz), and the like are mounted on one mobile phone. In the future, in addition to those RF antennas, there is a possibility that RF antennas such as a digital radio antenna (190 MHz), a next-generation multimedia communication antenna (210 MHz), and a UWB antenna (3-10 GHz) are mounted on one mobile phone.

In order to mount such a plurality of RF antennas and further to make electronic apparatuses smaller and thinner, it is required that RF antennas be made further smaller. In order to downsize the RF antennas, there is proposed a design approach utilizing wavelength shortening using permittivity and permeability of a material. The fractional shortening of wavelength is expressed by {1/√(εr×μr)} where εr is relative permittivity and μr is relative permeability. That is, by manufacturing an antenna using a substrate made of a material having a large relative permittivity or a large relative permeability, it is possible to construct a small-size antenna of the target frequency with a shorter antenna pattern. From the viewpoint of material physical property, whereas a dielectric material only has permittivity, a magnetic material has not only permeability but also permittivity. Therefore, by using a magnetic material effectively, it is possible to further downsize antennas.

Further, in recent years, a noncontact communication system called RFID (Radio Frequency Identification) is in widespread use. As noncontact communication methods used in the RFID system, a capacitive coupling system, an electromagnetic induction system, a radio wave communication system, and the like are used. Among them, the RFID system using the electromagnetic induction system is structured by, for example, a primary coil at a reader/writer side and a secondary coil at a transponder side. Magnetic coupling of those two coils enables data communication via the coils. Each of the antenna coils of the transponder and the reader/writer works as an LC resonant circuit. In general, resonant frequency of each of those coils is adjusted to carrier wave frequency of a carrier wave used for communication to resonate, to thereby be capable of set a suitable communication distance between the transponder and the reader/writer.

Further, in recent years, noncontact power feeding (noncontact electric power transmission, wireless electric power transmission) systems attract attention. As an electric power transmission method used in the noncontact power feeding system, an electromagnetic induction system, an electromagnetic resonance system, or the like is used. The electromagnetic induction system employs the principle similar to the system used in the above-mentioned RFID system, and transmits an electric power to a secondary-side coil by using a magnetic field generated when a current is applied to a primary-side coil. Meanwhile, as the electromagnetic resonance system, there are known one using electric field coupling and one using magnetic field coupling. The electromagnetic resonance system performs electric power transmission using the electric field or magnetic field coupling by using a resonance. Of them, the electromagnetic resonance system using the magnetic field coupling starts to garner attention in recent years. Resonant antennas thereof are designed by using coils.

Although the antenna coil is designed such that the antenna module resonates at a target frequency by itself, in a case where the antenna coil is mounted on an electronic apparatus actually, it is difficult to obtain the target characteristic. This is because a magnetic-field component generated from the antenna coil interferes (couples) with metals and the like existing in the vicinity thereof to thereby decrease an inductance component of the antenna coil to shift resonant frequency and further to generate eddy-current loss. As one of the countermeasures for them, a magnetic sheet is used. By providing a magnetic sheet between an antenna coil and metals existing in the vicinity thereof, a magnetic flux generated from the antenna coil is concentrated on the magnetic sheet, to thereby be capable of decreasing the metal interference.

Here, as one of the materials of the magnetic sheet, ferrite (ceramics mainly including iron oxide) is known. Since ferrite is hard and brittle, ferrite is extremely sensitive to a mechanical stress, and is crushed when a slight impact is applied thereto. Further, the way of crushing (crush direction, sizes of divided pieces, and the like) fluctuates permeability, and resonant frequency of the antenna coil is affected, which is problematic. In view of the above, each of Patent Literature 1 and Patent Literature 2 proposes a ferrite plate previously subjected to groove processing in order to control the way of crushing the ferrite.

Patent Literature 1 describes that dashed-line like grooves are formed on the “ceramic sheet” by laser processing, and the ceramic sheet is provided on an apparatus in a manner that the ceramic sheet is divided along the grooves. Patent Literature 1 describes that, therefore, a plurality of ceramic pieces are formed, and degree of freedom in providing the ceramic sheet on an apparatus is increased. Further, Patent Literature 2 describes a “sintered ferrite substrate” having grooves formed by grinding processing. Patent Literature 2 describes that, therefore, in providing the sintered ferrite substrate on an apparatus, the sintered ferrite plate is divided along the grooves, to thereby prevent irregular breakage and loss.

As described above, the ferrite plate described in Patent Literature 1 and Patent Literature 2 are both divided along the previously formed grooves. Therefore, in a case of using each of those ferrite plates as a magnetic sheet of an antenna coil, it is thought that resonant frequency of the antenna coil is adjusted based on permeability in the state of being divided along the grooves. However, in a case where a stress is applied to the ferrite plate when each of those ferrite plates is mounted on an apparatus or after mounting, there is a fear that the ferrite plate is further minutely divided and the permeability of the ferrite plate changes. In such a case, resonant frequency of the antenna coil, which is adjusted assuming that the ferrite plate is divided along the grooves, fluctuates from the expected value.

In view of the above-mentioned circumstances, it is desirable to provide a magnetic sheet capable of preventing resonant frequency from being displaced in company with fluctuation of permeability due to an unintentional division of ferrite, an antenna module using the magnetic sheet, an electronic apparatus on which the antenna module is mounted, and a method of manufacturing the magnetic sheet.

### SUMMARY OF INVENTION

In one aspect of the embodiment, a magnetic sheet for use with an antenna module is provided. The magnetic sheet may include a magnetically permeable layer having a plurality of randomly shaped pieces such that the magnetic sheet is configured to affect a resonance frequency of the antenna module. At least one of the randomly shaped pieces of the magnetic sheet may not have a rectangular or triangular shape.

In a further aspect of the embodiment, a method for making a magnetic sheet for use with an antenna module is provided. The method may comprise dividing a magnetically permeable layer into a plurality of randomly shaped pieces such that the magnetic sheet is configured to affect a resonance frequency of the antenna module, in which at least one of the randomly shaped pieces may not have a rectangular or triangular shape.

In another aspect of the embodiment, a method for making a magnetic sheet for use with an antenna module is provided. The method may comprise disposing a protective layer on at least one of a top surface or a bottom surface of a magnetically permeable layer so as to form the magnetic sheet, and rotating a roller device in a first direction and a second direction upon an outer surface of the magnetic sheet so as to divide the magnetically permeable layer into a plurality of randomly shaped pieces such that the magnetic sheet is configured to affect a resonance frequency of the antenna module. At least one of the randomly shaped pieces may not have a rectangular or triangular shape. The outer surface may be adjacent to one of the top surface or bottom surface of the magnetically permeable layer. The roller device may have a predetermined radius.

In yet a further aspect of the embodiment, a magnetic sheet comprising a magnetically permeable layer, a first protective layer, and a second protective layer is provided. The first protective layer may be disposed on a first surface of the magnetically permeable layer and the second protective layer may be disposed on a second surface of the magnetically permeable layer. The second surface may be opposite the first surface. The magnetically permeable layer may have a plurality of randomly shaped pieces. At least one of the randomly shaped pieces may not have a rectangular or triangular shape. The magnetic sheet may be configured to be usable with an antenna module and during operation the magnetically permeable layer may affect a desired resonance frequency of the antenna module.

### BRIEF DESCRIPTION OF DRAWINGS

FIG. 1 is a perspective view showing a magnetic sheet.

FIG. 2 is an exploded perspective view showing a layer structure of the magnetic sheet.

FIG. 3 is a plan view showing a ferrite layer of the magnetic sheet.

FIG. 4 is an exploded perspective view showing a ferrite plate sheet.

FIGS. 5 are diagrams showing how divide processing is performed.

FIG. 6 is a perspective view showing an antenna module.

FIG. 7 is a schematic view showing an electronic apparatus.

FIGS. 8 show a simulation model.

FIG. 9 is a graph showing a result of a simulation analysis.

FIG. 10 is a table showing resonant frequencies to respective real parts of complex relative permeability

FIG. 11 is a graph showing measurement result of complex relative permeability to frequency.

FIG. 12 is a table showing values of a real part and an imaginary part of the complex relative permeability at predetermined frequencies

FIG. 13 is a graph showing the relationship between a diameter of a roller and a division size of the ferrite layer.

FIG. 14 is a diagram showing ferrite layers.

FIG. 15 is a diagram showing ferrite layers.

### DESCRIPTION OF EMBODIMENTS

Hereinafter, an embodiment of the present invention will be described with reference to the drawings.

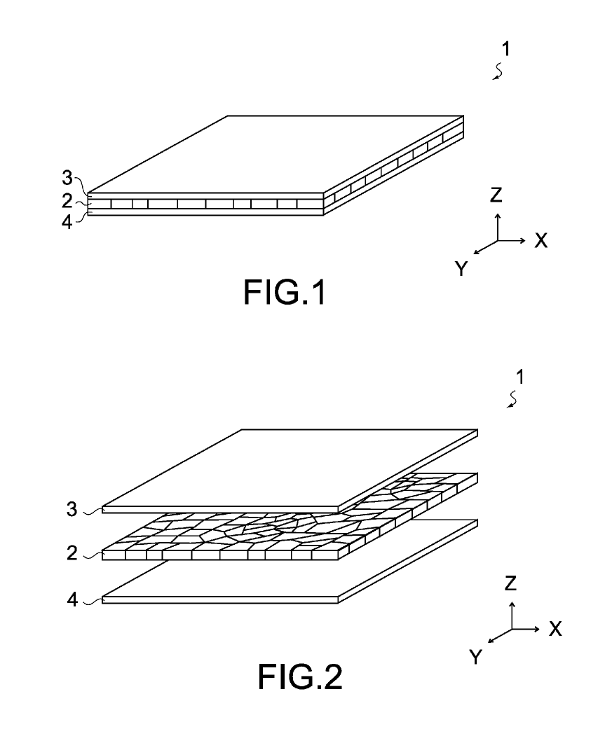

FIG. 1 is a perspective view showing a magnetic sheet 1 according to an embodiment of the present invention.

FIG. 2 is an exploded perspective view showing a layer structure of the magnetic sheet 1.

Hereinafter, the directions parallel to a sheet surface (first surface) of the magnetic sheet 1 are referred to as X direction and Y direction, and the laminate direction is referred to as Z direction (first direction).

As shown in FIGS. 1 and 2, the magnetic sheet 1 is structured such that a ferrite layer 2 is sandwiched between a first protective layer 3 and a second protective layer 4. Note that the shape of the magnetic sheet 1 shown in FIGS. 1 and 2 is a square, but the magnetic sheet 1 may have an arbitrary shape.

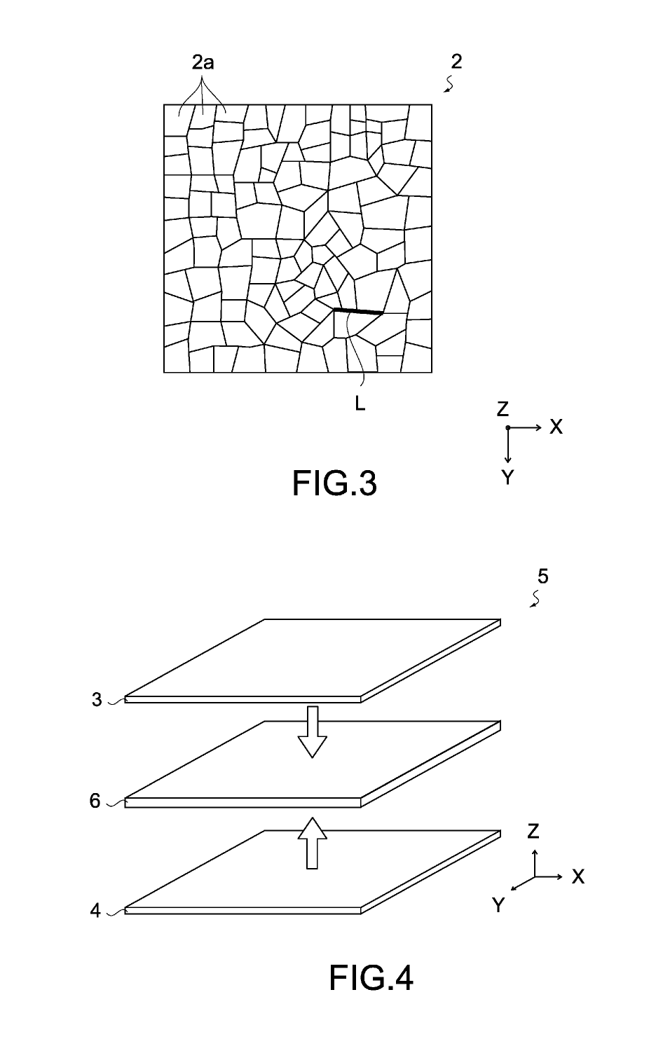

FIG. 3 is a plan view showing the ferrite layer 2.

The ferrite layer 2 may be made of any one of various kinds of ferrite such as Mn—Zn ferrite, Ni—Zn ferrite, Ni—Zn—Cu ferrite, Cu—Zn ferrite, Cu—Mg—Zn ferrite, Mn—Mg—Al ferrite, and YIG ferrite. The thickness of the ferrite layer 2 is, for example, 10 μm to 5 mm.

As shown in FIG. 3, the ferrite layer 2 is made of a plurality of randomly shaped ferrite pieces 2a wherein at least one such randomly shaped ferrite piece does not have a rectangular or triangular shape. As also shown in FIG. 3, one or more of the plurality of randomly shaped ferrite pieces have no interior angle equal to ninety degrees. The ferrite pieces 2a may be formed by dividing one ferrite plate by using a method mentioned below. The ferrite pieces 2a have shapes approximately constant in the Z direction and random in the X-Y directions (N-prism: N is an arbitrary number equal to or larger than 3). The ferrite layer 2 is formed such that the “longest side” of the ferrite pieces 2a is equal to or smaller than ten times the thickness. The longest side is the longest piece in the X-Y directions in a predetermined area (e.g., 10 mm×10 mm) of the ferrite layer 2. FIG. 3 shows the longest side L in the ferrite layer 2 shown here. Further, assuming that a ferrite piece 2a is a square, in the case where the longest side is equal to or smaller than ten times the thickness, the area of the ferrite piece 2a on the X-Y plane is equal to or smaller than 100 (10×10) times the square of the thickness.

The first protective layer 3 is adhered to the ferrite layer 2, protects the ferrite layer 2, and supports the ferrite pieces 2a at respective positions on the ferrite layer 2. The first protective layer 3 may be made of a flexible material, for example, a polymer material such as PET (Polyethylene terephthalate), acrylic, teflon (registered trademark), or polyimide, paper, a single-sided adhesive material, a double-sided adhesive material, or the like. Alternatively, as the first protective layer 3, a flexible printed board may be used.

The second protective layer 4 is adhered to the surface of the ferrite layer 2, the surface being opposite surface of the first protective layer 3, protects the ferrite layer 2, and supports the ferrite pieces 2a at predetermined positions on the ferrite layer 2. The second protective layer 4 is made of a material similar to the material of the first protective layer 3. The material of the first protective layer 3 may be the same as or different from the material of the second protective layer 4.

The magnetic sheet 1 is structured in the above manner. As described above, the ferrite layer 2 is divided into the plurality of ferrite pieces 2a having random shapes. Therefore, in a case where a stress is applied after an antenna coil is mounted on the magnetic sheet 1, the ferrite layer 2 will not be further divided, and is capable of preventing fluctuations of permeability mentioned below.

### Magnetic Sheet Manufacturing Method

First, a ferrite plate sheet, from which the magnetic sheet 1 is manufactured, is manufactured.

FIG. 4 is an exploded perspective view showing a ferrite plate sheet 5.

As shown in FIG. 4, the ferrite plate sheet 5 is formed by adhering the above-mentioned first protective layer 3 and second protective layer 4 to a ferrite plate 6. The ferrite plate 6 is a plate made of ferrite made of the above-mentioned material, and is not divided.

Next, “divide processing” is performed on the ferrite plate sheet 5.

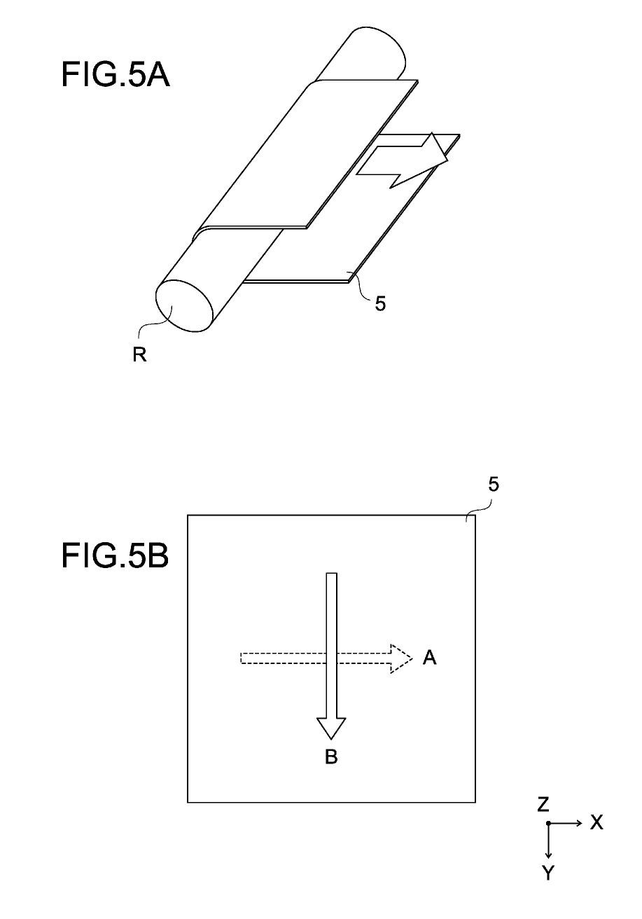

FIGS. 5 are diagrams showing how the divide processing is performed.

As shown in FIG. 5A, by winding the ferrite plate sheet 5 around a roller R and rotating the roller R, the ferrite plate sheet 5 is paid out. Here, the rotation speed of the roller R is arbitrarily selected. Since the first protective layer 3 and the second protective layer 4 are flexible, the stress generated when the ferrite plate sheet 5 is wound around the roller R is applied to the ferrite plate 6, to thereby crush the ferrite plate 6. The first protective layer 3 and the second protective layer 4 support the fragments of the crushed ferrite plate 6 at predetermined positions. Note that there is a predetermined relationship between the diameter of the roller R and how the ferrite plate 6 is crushed, and the relationship will be described below.

As shown in FIG. 5B, the ferrite plate sheet 5 is wound in one direction shown by an arrow A (X direction in FIG. 5B), and after that, the ferrite plate sheet 5 is wound in a direction shown by an arrow B, which is orthogonal to the direction of the arrow A (Y direction in FIG. 5B). As a result, a stress is applied in the two orthogonal directions, and the ferrite plate 6 is divided into the plurality of ferrite pieces 2a having random shapes. If the ferrite plate sheet 5 is wound in only one direction, the ferrite plate 6 will be divided in a stripe manner along the roller R. In this case, in a case where a stress is applied in a direction different from the stripe direction after mounting, the ferrite plate 6 will be further divided, and the permeability will fluctuate as described below. Note that the winding directions around the roller R shown by the arrows A and B are not limited to orthogonal directions, but may be two different directions.

As described above, the ferrite plate sheet 5 is manufactured and the ferrite plate 6 is crushed by the divide processing, to thereby manufacture the magnetic sheet 1.

### Structure of Antenna Module

An antenna module in which the magnetic sheet 1 and an antenna coil are modularized will be described.

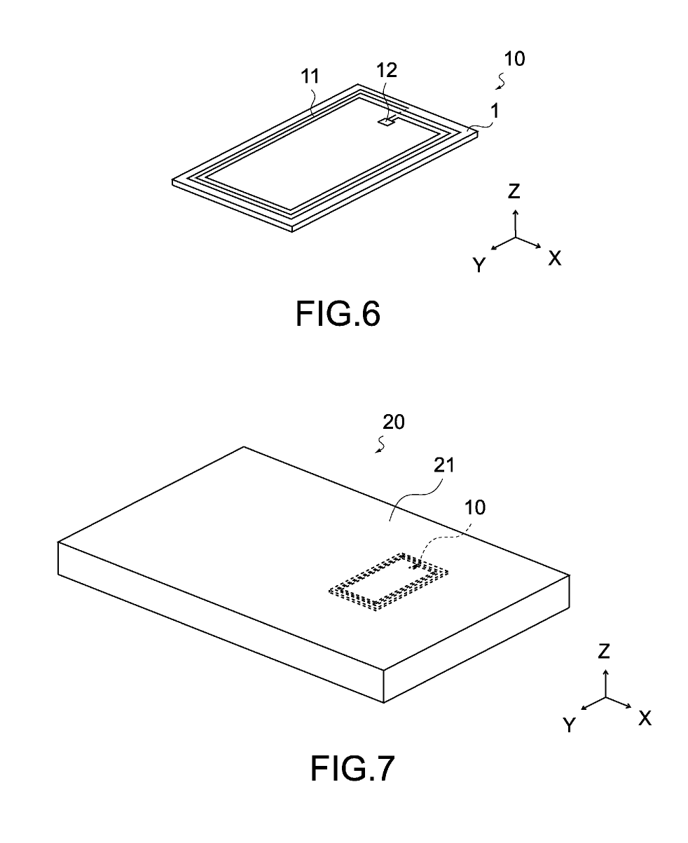

FIG. 6 is a perspective view showing an antenna module 10.

The antenna module 10 is used for an RF (Radio Frequency) communication, an RFID (Radio Frequency Identification) system, a noncontact power feeding system, or the like. Here, the description will be made assuming that the antenna module 10 is an antenna module for RFID. Not limited to the above, the antenna module 10 may be a module in which the magnetic sheet 1 and the antenna coil are combined.

As shown in FIG. 6, the antenna module 10 includes the magnetic sheet 1, an antenna coil 11 provided on the magnetic sheet 1, and an IC chip 12 connected to the antenna coil 11. The antenna coil 11 and the IC chip 12 are provided on the magnetic sheet 1 by, for example, adhesion.

The antenna coil 11 is a conductive wire wound in a coiled manner, and its shape and the number of winding are arbitrarily selected. The IC chip 12 is connected to the both ends of the antenna coil 11. In the RFID system, an electromagnetic wave entering the antenna module 10 generates an induced electromotive force in the antenna coil 11, which is supplied to the IC chip 12. Driven by this power, the IC chip 12 stores information from the entering electromagnetic wave (carrier wave) input by the antenna coil 11, or outputs information that the IC chip 12 stores to the antenna coil 11 as a carrier wave.

The size of the magnetic sheet 1 with respect to the antenna coil 11 may be arbitrarily selected. In view of the role of the magnetic sheet 1 that it prevents interference (couple) of a magnetic-field component generated from the antenna module 10 with metals and the like existing in the vicinity of the antenna module 10, it is preferable that the magnetic sheet 1 be spread over most part of the antenna coil 11.

### Structure of Electronic Apparatus

An electronic apparatus on which the antenna module 10 is mounted will be described.

FIG. 7 is a schematic view showing an electronic apparatus 20.

As shown in FIG. 7, the electronic apparatus 20 includes a case 21, and the case 21 accommodates the antenna module 10. The electronic apparatus 20 may be any kinds of apparatus capable of performing RF communication, RFID communication, noncontact power feeding, or the like such as a mobile information terminal, a mobile phone, or an IC (Integrated Circuit) card. Irrespective of the kind of the apparatus, the electronic apparatus 20 includes, most of the time, metal members such as a battery and a shield plate. Therefore, in the vicinity of the antenna module 10 mounted on the electronic apparatus 20, metals and the like that interfere (couple) with the magnetic-field component generated from the antenna module 10 exist.

The electronic apparatus 20 performs communication or electric power transmission between the electronic apparatus 20 and another apparatus (hereinafter referred to as target apparatus) via electromagnetic waves. In this case, the electronic apparatus 20 is designed so as to receive electromagnetic waves having a predetermined frequency and transmit electromagnetic waves having the same frequency. Specifically, the antenna coil 11 and its peripheral circuits form an LC resonant circuit, and, in a case where the frequency (resonant frequency) of the LC resonant circuit is the same as (close to) the frequency of the electromagnetic wave entering the antenna coil 11, an induced current is amplified and used as communication or electric power transmission. In the case where the electromagnetic wave is radiated from the antenna coil 11, similarly, the electromagnetic wave, which is the resonant frequency of the LC resonant circuit, is radiated. Because of this, in the case where the entering or radiated electromagnetic wave is different from the resonant frequency, communication efficiency or transmission efficiency is remarkably lowered. Therefore, the electronic apparatus 20 should be adjusted such that the electromagnetic wave becomes the same as (close to) the resonant frequency depending on a target apparatus. Note that this embodiment describes the antenna coil 11, but the shape of the antenna is not limited to the coil shape. In RF communication, antennas having various shapes such as a dipole shape and a reverse F shape are used. In such cases, the resonant frequency of the antenna should be adjusted also in view of peripheral materials.

### Effect Of Permeability of Magnetic Sheet to Resonant Frequency

In the antenna module 10 made of the magnetic sheet 1 and the antenna coil 11, how the resonant frequency of the antenna coil 11 is affected by the permeability of the magnetic sheet 1 will be described by using a simulation analysis.

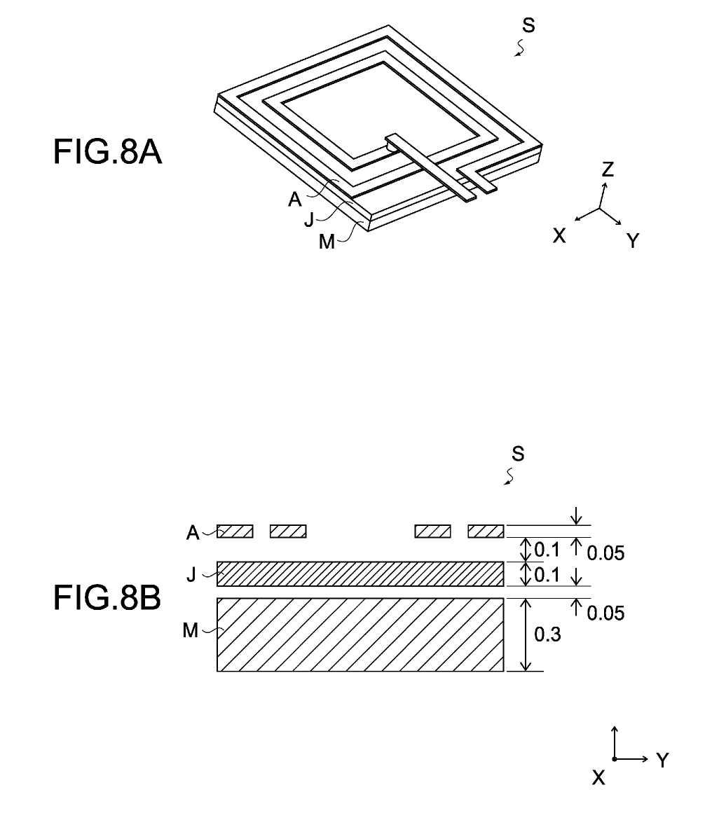

FIGS. 8 show a simulation model S. FIG. 8A is a schematic view showing the simulation model S, and FIG. 8B is a cross-sectional view showing the simulation model S. As shown in FIGS. 8, the simulation model S is made of a metal plate M, a magnetic sheet J, and an antenna coil A.

The metal plate M and the antenna coil A are both made of copper. The magnetic sheet J has a predetermined complex relative permeability. The complex relative permeability has a real part μᵣ′ and an imaginary part μᵣ″. The real part μᵣ′ relates to a magnetic flux density component having the phase same as the magnetic field. The imaginary part μᵣ″ is an index including retardation in phase, and corresponds to the loss of magnetic energy. The size of the metal plate M is 15.0 mm in the X direction, 14.5 mm in the Y direction, and 0.3 mm in thickness (Z direction). The magnetic sheet J is 15.0 mm in the X direction, 14.5 mm in the Y direction, and 0.1 mm in thickness (Z direction). The antenna coil A is 1.0 mm in line width (X direction or Y direction) and 0.05 mm in thickness (Z direction). The gap between the antenna coil A and the magnetic sheet J is 0.1 mm, and the gap between the magnetic sheet J and the metal plate M is 0.05 mm.

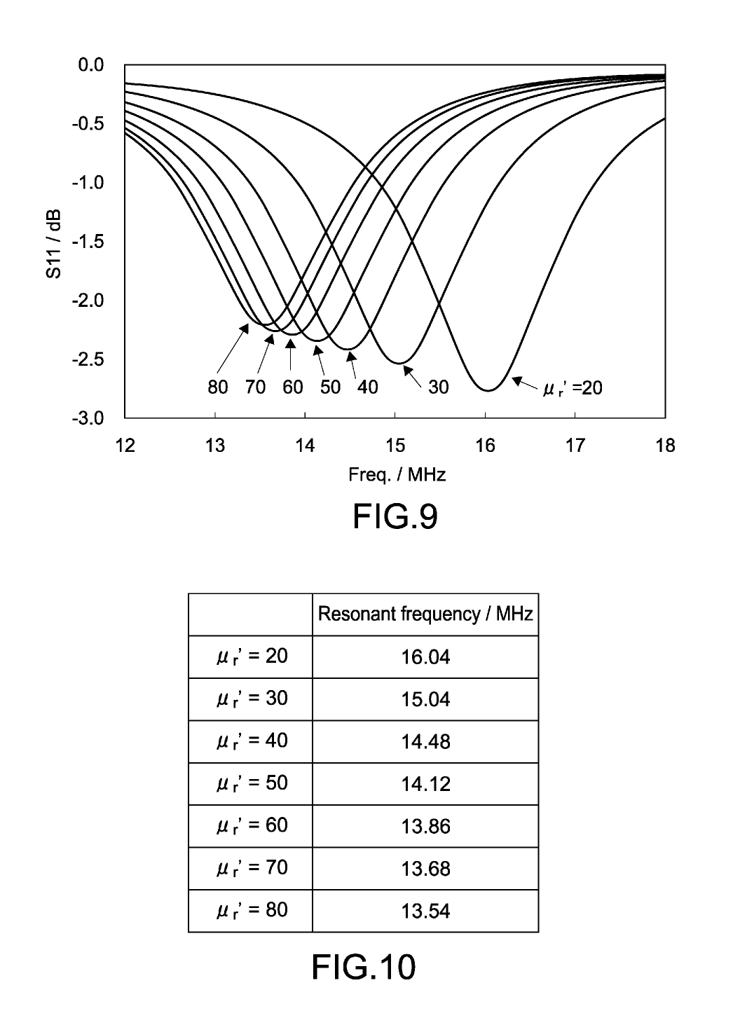

A simulation analysis is performed by using the above-mentioned simulation model S. FIG. 9 is a graph showing the result of the simulation analysis. S11 characteristic is one of S-parameters expressing transmission/reflection electricity characteristics of a circuit, and is a ratio of the electricity reflected by an input terminal to the electricity entering the input terminal. In the simulation analysis, the S11 characteristic is calculated in a case where the imaginary part μᵣ″ of the magnetic sheet J is 0 and the real part μᵣ′ is each one of 20, 30, . . . , 80. In each plot, the frequency having the smallest S11 characteristic is the resonant frequency. FIG. 10 is a table showing the resonant frequencies to the respective real parts μᵣ′.

As shown in FIGS. 9 and 10, when the permeability (real part μᵣ′) is different from each other, the resonant frequency is also different from each other. For example, it is understood that the resonant frequency difference of approximately 0.36 MHz is generated between the magnetic sheet J whose real part μᵣ′ of the complex relative permeability is 50 and the magnetic sheet J whose real part μᵣ′ is 40. It is understood that, because the antenna coil such as RFID is often designed such that the variation of resonant frequency falls within 0.1 MHz, the permeability difference of 10 becomes an extremely large factor for antenna variation. As described above, as the permeability of the magnetic sheet 1 fluctuates, the resonant frequency fluctuates.

### How Division Size of Ferrite Layer Influences on Permeability

In the antenna module 10 having the magnetic sheet 1, how the division size of the ferrite layer 2 influences on permeability will be described.

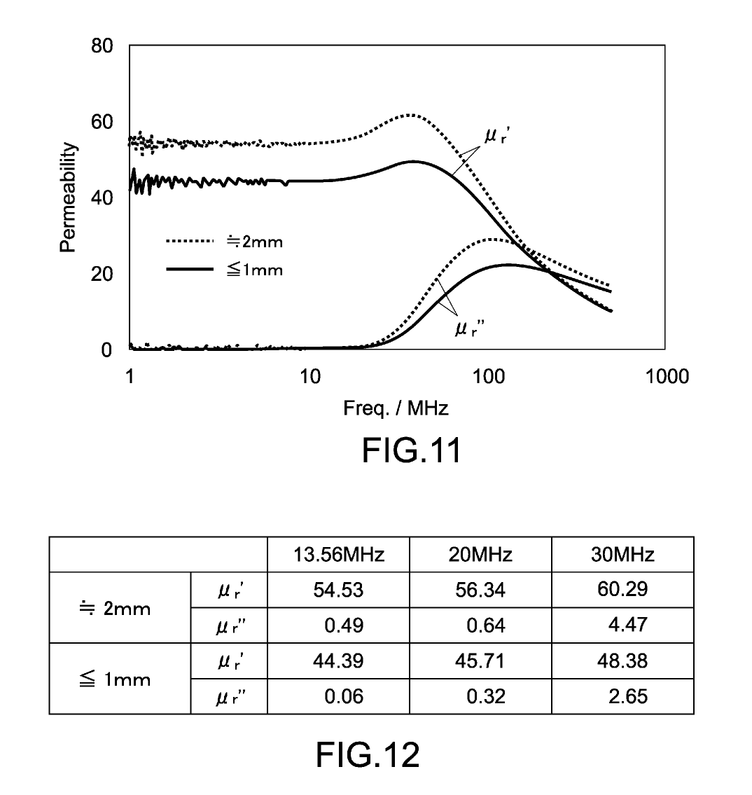

FIG. 11 shows measurement result of complex relative permeability (real part μᵣ′ and imaginary part μᵣ″) to frequency in antenna modules including a magnetic sheet having different division sizes of the ferrite layer, respectively.

The thickness of the ferrite layer is set to 0.1 mm. The measurement was made to the ferrite layer which was divided such that the longest side of the ferrite pieces formed by division is equal to or smaller than 1.0 mm (equal to or smaller than ten times the thickness) and the ferrite layer which was divided such that the average length of the ferrite pieces is approximately 2.0 mm. In FIG. 11, the solid lines show the former, and the dashed lines show the latter. FIG. 12 is a table showing the values of the real part μᵣ' and the imaginary part μᵣ″ at predetermined frequencies of the measurement result shown in FIG. 11.

As shown in FIGS. 11 and 12, according to the division size of the ferrite layer, the complex relative permeability (real part μᵣ′ and imaginary part μᵣ″) changes remarkably. As the division size becomes smaller, the real part μᵣ′ and the imaginary part μᵣ″ tend to decrease. For example, in 13.56 MHz used in RFID, the difference in the real part μᵣ′ is equal to or larger than 10. Also from the above-mentioned simulation analysis result, it is understood that the permeability difference due to division size influences resonant frequency greatly.

Based on the result shown in FIG. 11, it is expected that a magnetic sheet having ferrite pieces divided such that the average length is larger than 2.0 mm will have a further larger complex relative permeability. Meanwhile, it is thought that a magnetic sheet, which is obtained by further dividing a magnetic sheet having ferrite pieces divided such that the longest side is equal to or smaller than 1.0 mm, will have a further smaller value of complex relative permeability. However, in a case where a magnetic sheet having ferrite pieces divided such that the longest side is equal to or smaller than 1.0 mm is mounted on an antenna coil and an electronic apparatus, the magnetic sheet will not be further divided. That is, it is understood that, in the case of using the magnetic sheet divided such that the longest side is equal to or smaller than ten times the thickness, the permeability change before and after mounting is hardly generated.

Further, according to FIG. 11, it is understood that the imaginary part μᵣ″ of the complex relative permeability also decreases as the division size of the ferrite layer becomes smaller. The imaginary part μᵣ″ of the complex relative permeability expresses magnetic loss. From the viewpoint of the antenna coil, as the imaginary part μᵣ″ of the complex relative permeability is smaller, an antenna coil with little loss can be obtained.

### Relationship Between Roller Diameter And Division Size Of Ferrite Plate

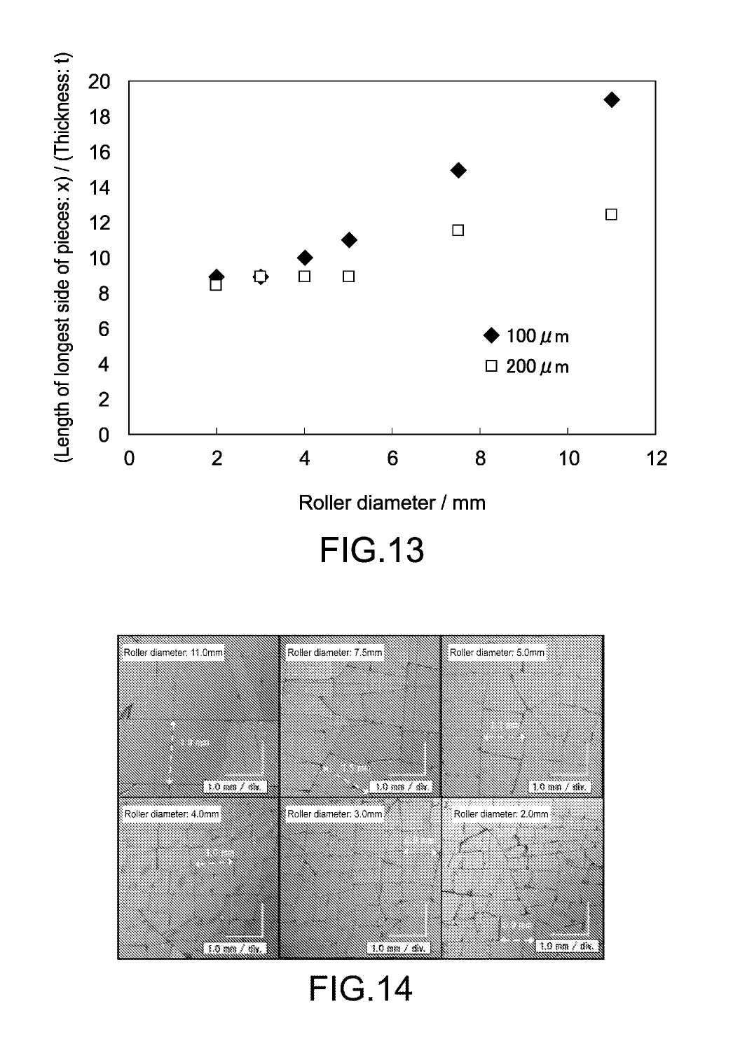

As described above, in this embodiment, by winding the ferrite plate sheet 5 having the ferrite plate 6 around the roller R, the ferrite plate 6 is crushed to thereby form the ferrite pieces 2a. In a case where the diameter of the roller R is different from one another in this case, the value of stress applied to the ferrite plate 6 is different from one another, and the division size of the ferrite layer 2 is different from one another. FIG. 13 is a graph showing the relationship between the diameter of the roller R (hereinafter, referred to as roller diameter) and the division size of the ferrite layer 2.

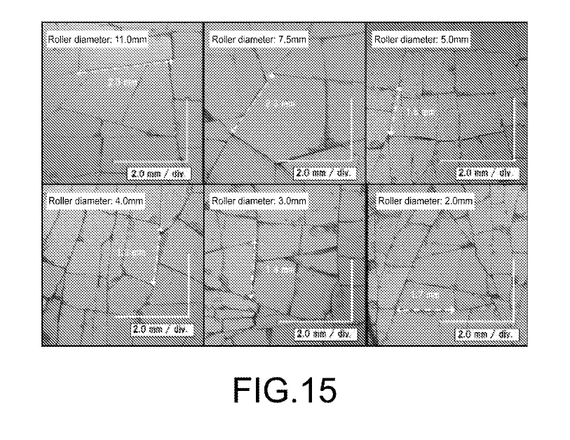

FIG. 13 shows the result of crushing the ferrite plate 6 having the thickness of each one of 100 μm and 200 μm by using the roller having the roller diameter of each one of 11.0 mm, 7.5 mm, 5.0 mm, 4.0 mm, 3.0 mm, and 2.0 mm. The vertical axis in FIG. 13 shows a ratio (x/t) of the length (x) of the longest side of the ferrite pieces 2a to the thickness (t). Further, FIGS. 14 and 15 show the ferrite layers 2 divided by using the rollers R having different roller diameters. FIG. 14 shows the crushed ferrite plates 6 having the thickness of 100 μm, and FIG. 15 shows the crushed ferrite plates 6 having the thickness of 200 μm. In FIGS. 14 and 15, each white dashed line shows the longest side in the shown area, and the length is shown.

As shown in FIGS. 14 and 15, the ferrite plate 6 is crushed by the roller R, to thereby be divided into the ferrite pieces 2a having random shapes. Therefore, if a stress is further applied to the ferrite layer 2, it is possible to prevent the ferrite layer 2 from being divided in a predetermined direction.

Further, as shown in FIGS. 13 to 15, as the roller diameter becomes smaller, the size of each of the ferrite pieces 2a becomes smaller. Further, it is understood that, as the roller diameter becomes smaller, the ratio (x/t) of the length of the longest side of the ferrite pieces 2a to the thickness converges on the value a little less than 10. Further, in FIGS. 14 and 15, in the case where the roller diameter is equal to or smaller than 4.0 mm, it is understood that the length of the longest side of the ferrite pieces 2a of the ferrite layer 2 having the thickness of 100 μm is equal to or smaller than 1.0 mm, and the length of the longest side of the ferrite pieces 2a of the ferrite layer 2 having the thickness of 200 μm is equal to or smaller than 2.0 mm. In view of the above, by dividing the ferrite layer 2 such that the longest side of the ferrite pieces 2a is equal to or smaller than the ten times the thickness (area of each of the ferrite pieces 2a is equal to or smaller than 100 times the square of the thickness), it is possible to prevent the ferrite layer 2 from being further divided in the case where the magnetic sheet 1 is mounted on the electronic apparatus 20 as the antenna module 10.

As described above, in this embodiment, the ferrite layer 2 is divided into the plurality of ferrite pieces 2a having the longest side equal to or smaller than ten times the thickness. Therefore, in the case where the magnetic sheet 1 is mounted as the antenna module 10 or the antenna module 10 is mounted on the electronic apparatus 20, the ferrite layer 2 is not further divided. Therefore, it is possible to prevent the resonant frequency of the antenna coil 11 from fluctuating in association with fluctuation of permeability.

The present invention is not limited to the above-mentioned embodiment, and can be modified insofar as it is within the gist of the present invention.

In the above-mentioned embodiment, the divide processing is performed by using a roller. However, not limited to this, any method capable of crushing a ferrite plate into ferrite pieces may be used. For example, in a case where the elasticity of the first protective layer or the second protective layer is large or the like, it is possible to crush the ferrite plate by applying a pressure force in the Z direction.

Although preferred embodiments of the present invention have been described in detail with reference to the attached drawings, the present invention is not limited to the above examples. It should be understood by those skilled in the art that various modifications, combinations, sub-combinations and alterations may occur depending on design requirements and other factors insofar as they are within the scope of the appended claims or the equivalents thereof.

1. A magnetic sheet for use with an antenna module, the magnetic sheet comprising:
a magnetically permeable layer, which has a thickness in a first direction, having a plurality of randomly shaped pieces on a first surface being perpendicular to the first direction such that the magnetic sheet is configured to affect a resonance frequency of the antenna module, at least one of the randomly shaped pieces not having a rectangular or triangular shape.

2. The magnetic sheet of claim 1, in which at least some of the plurality of pieces have no interior angle equal to ninety degrees.

3. The magnetic sheet of claim 1, further comprising a first protective layer disposed on a the first surface of the magnetically permeable layer, the first protective layer supporting the plurality of pieces so as to maintain each of the plurality of pieces at its respective position in the magnetically permeable layer.

4. The magnetic sheet of claim 3, further comprising a second protective layer disposed on a second surface of the magnetically permeable layer, the second surface being opposite the first surface, the second protective layer further supporting the plurality of pieces so as to maintain each of the plurality of pieces at its respective position in the magnetically permeable layer.

5. The magnetic sheet of claim 4, in which the first protective layer is composed of material different than that of the second protective layer.

6. The magnetic sheet of claim 1, in which the magnetically permeable layer is composed of a ferrite material.

7. The magnetic sheet of claim 1, in which the thickness of the magnetically permeable layer is between approximately 10 μm and approximately 5 mm.

8. The magnetic sheet of claim 7, in which each of the plurality of pieces includes a plurality of sides, in which a longest one of the sides is approximately equal to or less than ten times the thickness of the magnetically permeable layer.

9. The magnetic sheet of claim 8, in which the longest one of the sides is approximately less than or equal to 1 mm and the thickness of the magnetically permeable layer is approximately less than or equal to 0.1 mm.

10. A method for making a magnetic sheet having a thickness in a first direction for use with an antenna module, the method comprising:
dividing a magnetically permeable layer into a plurality of randomly shaped pieces on a first surface being perpendicular to the first direction such that the magnetic sheet is configured to affect a resonance frequency of the antenna module, at least one of the randomly shaped pieces not having a rectangular or triangular shape.

11. The method of claim 10, in which at least some of the plurality of pieces have no interior angle equal to ninety degrees.

12. The method of claim 10, further comprising disposing a first protective layer on the first surface, the first protective layer supporting the plurality of pieces so as to maintain each of the plurality of pieces at its respective position in the magnetically permeable layer.

13. The method of claim 12, further comprising disposing a second protective layer on a second surface of the magnetically permeable layer, the second surface being opposite the first surface, the second protective layer supporting the plurality of pieces so as to maintain each of the plurality of pieces at its respective position in the magnetically permeable layer.

14. The method of claim 10, in which the magnetically permeable layer is divided by rotating a roller device upon the first surface.

15. A method for making a magnetic sheet for use with an antenna module, the method comprising:
disposing a protective layer on at least one of a top surface or a bottom surface of a magnetically permeable layer so as to form the magnetic sheet; and
rotating a roller device in a first direction and a second direction upon an outer surface of the magnetic sheet so as to divide the magnetically permeable layer into a plurality of randomly shaped pieces such that the magnetic sheet is configured to affect a resonance frequency of the antenna module, at least one of the randomly shaped pieces not having a rectangular or triangular shape , the outer surface being adjacent to one of the top surface or bottom surface of the magnetically permeable layer, the roller device having a predetermined radius.

16. The method of claim 15, in which at least some of the plurality of pieces have no interior angle that is equal to ninety degrees.

17. The method of claim 15, in which the predetermined radius of the roller device is related to a size of each of the plurality of pieces such that as the radius decreases the size of each of the plurality of pieces decreases.

18. A magnetic sheet comprising:
a magnetically permeable layer;
a first protective layer;
a second protective layer;
in which the first protective layer is disposed on a first surface of the magnetically permeable layer and the second protective layer is disposed on a second surface of the magnetically permeable layer, the second surface being opposite the first surface,
in which the magnetically permeable layer has a plurality of randomly shaped pieces on the first surface, at least one of the randomly shaped pieces not having a rectangular or triangular shape, and
in which the magnetic sheet is configured to be usable with an antenna module and during operation the magnetically permeable layer affects a desired resonance frequency of the antenna module.

19. The magnetic sheet of claim 18, in which each of the plurality of pieces includes a plurality of sides such that a longest one of the plurality of sides is approximately equal to or less than ten times a thickness of the magnetically permeable layer, the thickness of the magnetically permeable layer being between approximately 10 μm and approximately 5 mm.

20. The magnetic sheet of claim 19, in which the longest one of the plurality of sides is approximately less than or equal to 1 mm and the thickness of the magnetically permeable layer is approximately less than or equal to 0.1 mm.
